(19) United States
(12) Patent Application Publication
(10) Pub. No.: US 2007/0235089 A1
(43) Pub. Date: Oct. 11, 2007

(54) VEHICLE FUEL PUMP MOUNTING ARRANGEMENT

(75) Inventor: Munetaka Koike, Iwata-shi (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/733,600

(22) Filed: Apr. 10, 2007

(30) Foreign Application Priority Data
Apr. 11, 2006 (JP) 2006-108149

(51) Int. Cl. F02M 37/04

(52) U.S. Cl. 137/565.17

(57) ABSTRACT

A vehicle, such as a motorcycle, includes a fuel tank and a fuel pump mounting arrangement that inhibits or prevents fuel from leaking from the fuel tank. The fuel pump mounting arrangement includes a mount assembly that secures the fuel pump within the fuel tank. At least a portion of the fuel pump mount assembly is embedded in a wall portion of the fuel tank, and includes a plate and a plurality of nuts fixed to the plate.

### RELATED APPLICATIONS

This application is related to, and claims priority from, Japanese Patent Application No. 2006-108149, filed Apr. 11, 2006, the entirety of which is incorporated by reference herein and made a part of the present specification.

### BACKGROUND OF THE INVENTION

1. Field of the Invention

This invention relates to a vehicle and a method for manufacturing a vehicle. More particularly, this invention relates to a vehicle having a fuel tank and a method for manufacturing the fuel tank.

2. Description of the Related Art

Vehicles, such as motorcycles, for example, may incorporate a fuel pump within a fuel tank of the vehicle. For example, such a motorcycle is shown in Japanese Publication No. 2005-343212. In particular, Japanese Publication No. 2005-343212 discloses a motorcycle having a fuel pump disposed inside of a fuel tank. The fuel pump is fastened to the fuel tank by fastening members. Specifically, the fuel pump of the motorcycle is fastened to the fuel tank by a plurality of bolts coupled to a plurality of nuts arranged inside of the fuel tank.

Furthermore, it is known to secure a fuel pump to a fuel tank constructed of a resin-based material using a plurality of nuts embedded in a wall portion of the fuel tank and bolts coupled with the respective nuts. The aforementioned fuel tank is formed by a forming process in which the resin is molded around the nuts by insert molding.

### SUMMARY OF THE INVENTION

The present inventors have discovered that, in the conventional method of embedding the plurality of nuts into the wall of a molded fuel tank in which the molded fuel tank later shrinks as it cools, a problem arises in that the plurality of the nuts move from a desired original position due to being pulled by the shrinking resin. As a result, when the fuel pump is fastened to the fuel tank by coupling bolts with the plurality of the nuts, the position where the fuel pump is fastened is displaced from the desired position and fuel may leak between the wall portion of the fuel tank and the fuel pump.

An aspect of one or more embodiments of the present invention is to provide a vehicle that can inhibit fuel from leaking from a fuel tank. Another aspect of one or more embodiments of the present invention is to provide a method for manufacturing a vehicle that can inhibit fuel from leaking from a fuel tank.

An aspect of an embodiment is a vehicle including a fuel tank made from a resin-based material. A fuel pump is disposed inside of the fuel tank, and a fuel pump mount assembly secures the fuel pump to the fuel tank. At least a portion of the fuel pump mount assembly is embedded in a wall of the fuel tank, and includes a plate and at least one fastening mechanism, such as a nut, secured to the plate.

In the vehicle described above, the fuel pump mount assembly embedded in the wall portion of the fuel tank includes the plate and a nut fixed to the plate. Thus, when the fuel tank is molded by a forming process in which resin is molded, even though the molded fuel tank shrinks during cooling after the molding process, the nut is prevented from moving due to being pulled by the shrinking resin because the nut is fixed to the plate. Thereby, when the fuel pump is fastened inside of the fuel tank using the fuel pump mount assembly, the position where the fuel pump is fastened is prevented from displacing from the desired position. As a result, fuel leaks between the wall portion of the fuel tank and the fuel pump can be avoided that may otherwise occur due to the position where the fuel pump is fastened being off from the desired position.

Another aspect of a preferred embodiment involves a vehicle as described above in which a portion of the fuel pump mount assembly positioned inside of the fuel tank is covered with a resinous section forming the fuel tank. Accordingly, a boundary portion inside of the fuel tank between the resinous section forming the fuel tank and the fuel pump mount assembly is prevented from being exposed. Thereby, occurrence of a fuel leak that may otherwise result from the fuel entering the boundary portion between the resinous section forming the fuel tank and the fuel pump mount assembly is inhibited or prevented.

Another aspect of a preferred embodiment involves a vehicle as described above in which the nut of the fuel pump mount assembly is arranged to protrude within the inside volume of the fuel tank and is covered with a resinous section forming the fuel tank. That is, preferably the nut protrudes beyond an inner surface of a portion of the fuel tank surrounding the portion of the fuel tank in which the nut is embedded. As a result, a boundary portion between the resinous section forming the fuel tank and the nut of the fuel pump mount assembly can be prevented from being exposed. Thereby, occurrence of a fuel leak that may otherwise result from the fuel entering the boundary portion between the resinous section forming the fuel tank and the nut of the fuel pump mount assembly is inhibited or prevented.

Another aspect of a preferred embodiment involves a vehicle as described above in which the nut of the fuel pump mount assembly has a recessed portion formed in an outer surface of the nut. A portion of the resin-based material that forms the fuel tank is embedded in the recessed portion of the nut. Accordingly, the nut of the fuel tank mount assembly is joined to the wall portion of the fuel tank. The fuel pump mount assembly thus is inhibited or prevented from separating from the wall portion of the fuel tank.

Another aspect of a preferred embodiment involves a vehicle as described above in which both the plate and the nut of the fuel pump mount assembly are made from metal and the nut is caulked to the plate. That is, preferably, the nut is secured to the plate using an adhesive that is selected so as to also provide a seal function. Accordingly, the nut can easily be secured to the metal plate.

Another aspect of a preferred embodiment involves a vehicle as described above in which the plate of the fuel pump mount assembly is formed to be in the shape of a ring, the fuel pump mount assembly includes a plurality of the nuts, and the plurality of the nuts are arranged on the ring plate in such a manner that the respective nuts are spaced apart from each other by a predetermined distance between centers of the neighboring nuts. Accordingly, fuel is prevented from leaking between the wall portion of the fuel tank and the fuel pump because an even sealing force is developed by fastening the fuel pump to the fuel tank using the plurality of the nuts arranged on the ring plate.

Another aspect of a preferred embodiment involves a method for manufacturing a vehicle including assembling a fuel pump mount assembly by securing at least one nut to a plate. The method also includes forming a fuel tank from a resin-based material having a wall portion by a rotational molding process. A portion of the fuel pump mount assembly is embedded in the wall portion of the fuel and the fuel pump is secured to the fuel tank using the fuel pump mount assembly such that the fuel pump is disposed within the fuel tank.

Another aspect of a preferred embodiment involves the method described above wherein, after forming the fuel pump mount assembly, the fuel tank is formed by the rotational molding. Thus, even though the resinous molded work piece that forms the fuel tank shrinks as it cools, the nuts are prevented from being undesirably moved by the shrinking resin because the nut is fixed to the metal plate. Thereby, when the fuel pump is fastened by the fuel pump mount assembly, the position of the fuel pump is inhibited or prevented from being displaced from the desired position. As a result, the problem of fuel leaks between the wall portion of the fuel tank and the fuel pump can be avoided as a result of the fuel pump being displace from the desired position. Also, because the fuel tank is formed by rotational molding, even though the fuel pump mount assembly has a complicated configuration, the fuel tank can be formed in only one molding step. Thereby, the manufacturing of the fuel tank is simplified.

Another aspect of a preferred embodiment involves the method described above wherein the fuel pump mount assembly is in the shape of a ring and is positioned inside of a mold. A resin powder is introduced to the inside of the mold and is caused to adhere to an inner surface of the mold. At least a portion of the inner surface of an area of the metal mold for rotational molding surrounded by the fuel pump mount assembly is formed to have a concave shape. Accordingly, when the molded fuel tank later shrinks during cooling, the concave area shrinks from the outside to the inside and results in the concave as-molded area becoming a substantially flat surface. Therefore, when the fuel pump is fastened to the wall portion positioned in the area of the fuel tank surrounded by the fuel pump mount assembly, a gap is prevented from occurring between the wall portion of the fuel tank and the fuel pump. Such a feature further prevents fuel from leaking between the wall portion of the fuel tank and the fuel pump.

Another aspect of a preferred embodiment involves the method described above wherein the forming of the fuel tank includes positioning the fuel pump mount assembly within a mold for rotational molding of the fuel tank. The method further includes introducing a resin powder to the inside of the mold and causing the resin powder to adhere to an inner surface of the mold so that a portion of the fuel pump mount assembly positioned inside of the fuel tank is covered with the resin powder which adheres to the inner surface. Accordingly, in the inside of the fuel tank, the boundary portion between the resinous section forming the fuel tank and the nut of the fuel pump mount assembly is prevented from being exposed. Thereby, occurrence of a fuel leak that may otherwise result from the fuel entering the boundary portion between the fuel tank and the nut of the fuel pump mount assembly is inhibited or prevented.

Another aspect of a preferred embodiment involves the method described above wherein the forming of the fuel tank includes positioning the fuel pump mount assembly within a mold for rotational molding so that the nut of the fuel pump mount assembly protrudes to the inside of the metal mold for rotational molding. The method further includes introducing a resin powder into the mold and causing the resin powder to adhere to an inner surface of the mold so that the nut of the fuel pump mount assembly is covered with the resin powder that adheres to the inner surface. Accordingly, in the inside of the fuel tank, the boundary portion between the resin forming the fuel tank and the nut of the fuel pump mount assembly is inhibited or prevented from being exposed. Thereby, fuel leaks that may otherwise occur from fuel entering the boundary portion between the fuel tank and the nut of the fuel pump mount assembly is inhibited or prevented.

Another aspect of a preferred embodiment involves the method described above wherein the nut of the fuel pump mount assembly has a recessed portion defined in an outer surface of the nut. The causing the resin powder to adhere to the inner surface of the mold includes causing the resin powder to adhere to become embedded in the recessed portion of the nut. As a result, the nut is joined to the wall portion of the fuel tank. The fuel pump mount assembly thus is therefore inhibited or prevented from becoming separated from the wall portion of the fuel tank.

Another aspect of a preferred embodiment involves the method described above wherein the forming the fuel pump mount assembly includes securing the metal nut to the plate with an adhesive. Accordingly, the nut can be easily fixed to the plate. Preferably, the adhesive is selected to create a seal between the plate and the nut.

### BRIEF DESCRIPTION OF THE DRAWINGS

These and other features, aspects and advantages of the present invention are described below with reference to drawings of a preferred embodiment, which is intended to illustrate, but not to limit, the present invention. The drawings contain eleven (11) figures.

FIG. 1 is a side elevation view of a motorcycle having certain features, aspects and advantages of the present invention.

FIG. 2 is a lateral cross sectional view of a fuel tank of the motorcycle of FIG. 1 including a fuel pump mount assembly.

FIG. 3 is a plan view of the fuel tank and fuel pump mount assembly of FIG. 2.

FIG. 4 is a cross sectional view taken along the line 100-100 of FIG. 3.

FIG. 5 is a perspective view of the fuel pump mount assembly of FIG. 2 separate from the fuel tank.

FIG. 6 is a plan view of an internal structure of the fuel tank of the motorcycle of FIG. 1, with certain components shown in dashed line.

FIG. 7 is a side elevation, partial cross sectional view of the fuel tank of the motorcycle of FIG. 1.

FIG. 8 is a lateral cross sectional view of the fuel tank of the motorcycle of FIG. 1, showing a partition and a portion of the fuel pump mount assembly.

FIG. 9 is a schematic illustration of a rotational molding method for manufacturing the fuel tank of the motorcycle of FIG. 1.

FIG. 10 is schematic illustration of a preferred mold for manufacturing the fuel tank of the motorcycle of FIG. 1.

FIG. 11 is a schematic illustration of the mold of FIG. 10, wherein the molded fuel tank is further cooled in comparison with the molded fuel tank of FIG. 10.

### DETAILED DESCRIPTION OF THE PREFERRED EMBODIMENT

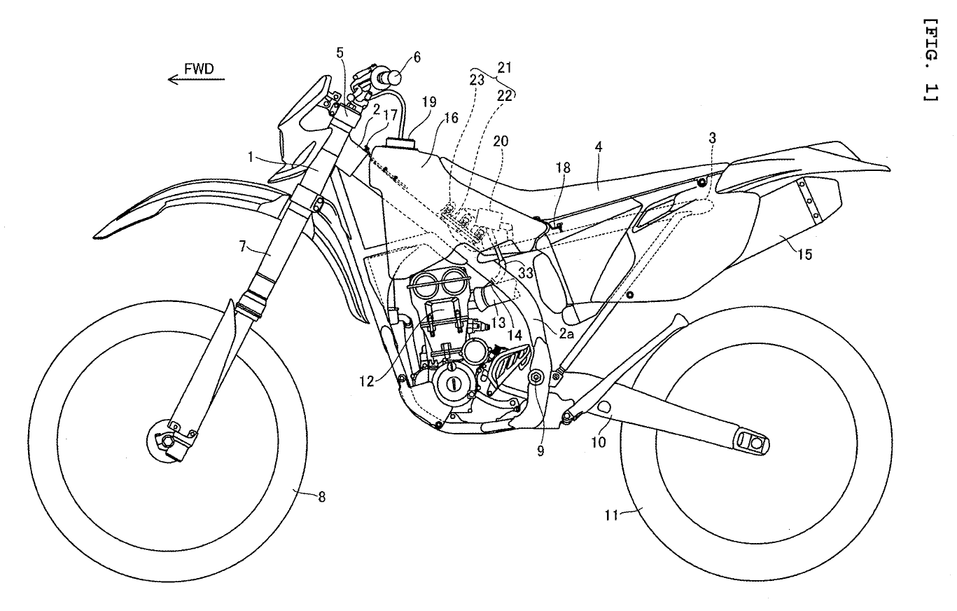

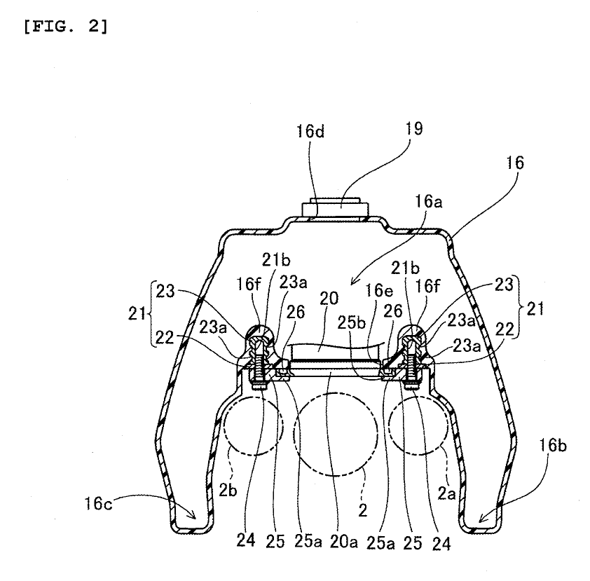

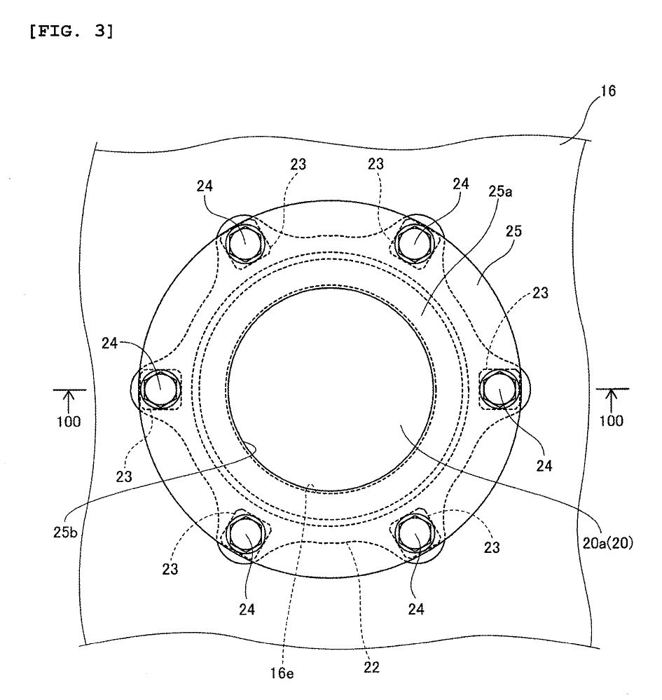

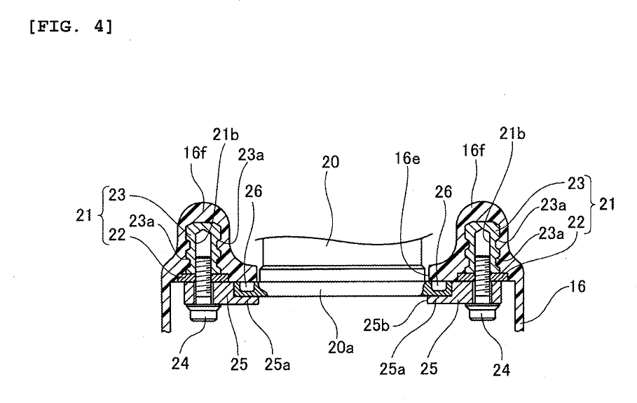

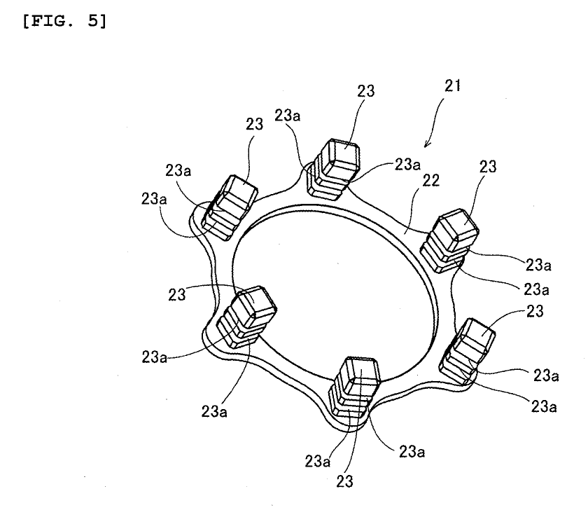

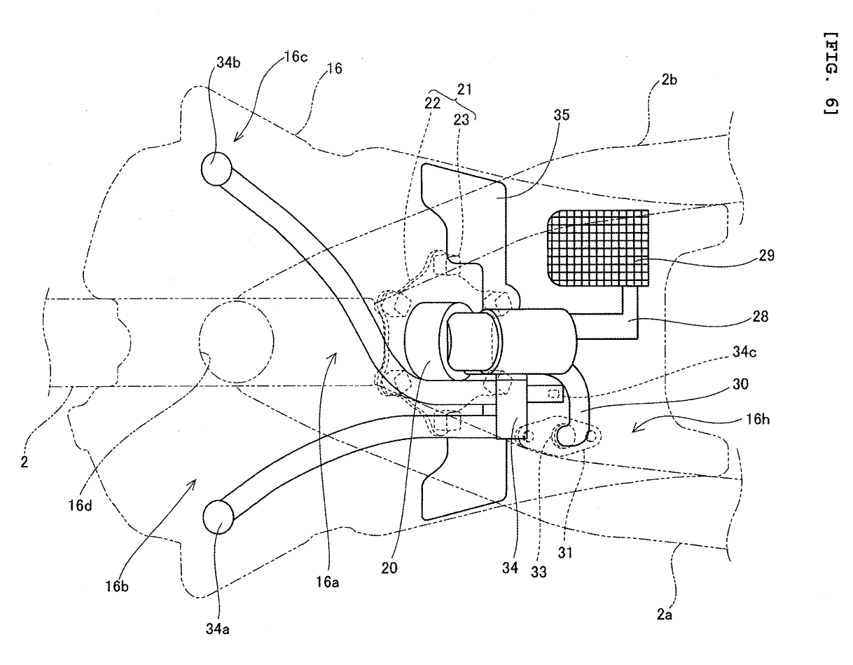

FIG. 1 is a side elevation view of a vehicle and, more specifically, of a motorcycle having certain features, aspects and advantages of the present invention. FIG. 2 is a cross sectional view of a fuel tank of the motorcycle of FIG. 1. FIG. 3 is a plan view of a lower portion of the fuel tank of FIG. 2, including a fuel pump mount assembly. FIG. 4 is a cross sectional view taken along the line 100-100 of FIG. 3. FIG. 5 is a perspective view of a fuel pump mount assembly embedded in a wall portion of the fuel tank shown in FIG. 2. FIGS. 6-8 are illustrations of an internal structure of the fuel tank of the motorcycle of FIG. 1.

In the motorcycle of FIG. 1, a front end portion of a main frame 2 is coupled to a head tube 1. This main frame 2 has portions 2a and 2b (see FIG. 6) bifurcating to extend to the right and left relative to a fore and aft direction of a vehicle body. The main frame 2 is formed to extend downward in a rearward direction. Seat rails 3 extending upward in a rearward direction are coupled to the main frame 2. A seat 4 is attached to upper portions of the seat rails 3. A steering mechanism 5 is coupled to the head tube 1 for pivotal movement. Handlebars 6 are attached to an upper portion of the steering mechanism 5. A front fork assembly 7 is coupled to a lower portion of the steering mechanism 5. A front wheel 8 is coupled to a bottom end portion of the front fork assembly 7 for rotation. A front end portion of a swing arm 10 is coupled to a rear end portion of the main frame 2 through a pivot shaft 9. A rear wheel 11 is coupled to a rear end portion of the swing arm 10.

An engine 12 is mounted to a lower portion of the main frame 2. A throttle body 13 and an injector 14 are attached to the engine 12. A muffler 15 is connected to the engine 12 through an exhaust pipe, which is not shown. A fuel tank 16 constructed from a resin-based material and having a generally saddle shape is disposed above the engine 12. As described below, the fuel tank 16 preferably is constructed with a molding technique and, more specifically, a rotational molding technique. Thus, preferably, the resin-based material is a suitable material for rotational molding, such as a plastic material including polyethylene, polypropylene, nylon and others. An attaching member 17 fixes a front portion of the fuel tank 16 to the main frame 2, and another attaching member 18 fixes a rear portion of the fuel tank 16 to the seat rails 3.

The fuel tank 16, as shown in FIG. 2, includes a central section 16a positioned in a center of the vehicle, a left section 16b positioned on the left side in the fore to aft direction of the vehicle and a right section 16c positioned on the right side in the fore to aft direction of the vehicle. The central section 16a of the fuel tank 16 is positioned above the main frame 2. The left section 16b of the fuel tank 16 is formed to extend downward from the central section 16a over the portion 2a of the main frame 2. The right section 16c of the fuel tank 16 is formed to extend downward from the central section 16a over the portion 2b of the main frame 2.

A fuel filling opening 16d for pouring fuel into the fuel tank 16 is defined in a wall portion on a top surface of the central section 16a of the fuel tank 16d. A cap 19 for closing the fuel filling opening 16d is fitted into the fuel pouring opening 16d of the fuel tank 16. Also, as shown in FIGS. 2-4, a fuel pump 20 is disposed in a lower portion of the central section 16a of the fuel tank 16. A body of the fuel pump 20 is positioned inside of the fuel tank 16. The fuel pump 20 has a disk-shaped attaching section 20a placed outside of the fuel tank 16.

A fuel pump inserting aperture 16e for inserting the body of the fuel pump 20 into the inside of the fuel tank 16 is defined in a wall portion of the bottom surface of the central section 16a of the fuel tank 16. The attaching section 20a of the fuel pump 20 is coupled to the body of the fuel pump 20 through the fuel pump inserting aperture 16e of the fuel tank 16. Additionally, the disk-shaped attaching section 20a of the fuel pump 20 has a diameter larger than a diameter of the fuel pump inserting aperture 16e of the fuel tank 16. Also, a fuel pump mounting arrangement includes a fuel pump mount assembly 21, for fastening the body of the fuel pump 20 to the inside of the fuel tank 16 is embedded in a wall portion adjacent to the fuel pump inserting aperture 16e of the fuel tank 16.

As shown in FIG. 5, the fuel pump mount assembly 21 includes an aluminum plate 22 and one or more fastening mechanisms. In the illustrated arrangement, the fastening mechanisms comprise six aluminum nuts 23 fixed to the plate 22. However, in another arrangement, the nuts 23 may be replaced with bolts. Moreover, the fastening mechanism that is secured to the plate 22 may be all or part of another type of fastener, other than the threaded fasteners illustrated. The plate 22 is formed in the shape of a ring, and the six nuts 23 are circularly arranged in such a manner that the respective nuts 23 are spaced apart from each other by a predetermined distance (pitch) between centers of the neighboring nuts. Also, the aluminum nuts 23 are caulked to the aluminum plate 22 to be fixed to the plate 22. That is, the nuts 23 are secured to the plate 22 with an adhesive and, preferably, by an adhesive material selected to provide a seal between the nuts 23 and the plate 22. Furthermore, although the plate 22 and nuts 23 preferably are constructed of aluminum, other suitable materials may be used as well, including other metals and plastics, for example. Each nut has two recessed portions 23a defined circumferentially in an outer surface of the nut 23 to be annular in shape. As shown in FIGS. 2 and 4, a threaded bolt hole 21b of each nut 23 is blind, or defined not to pierce through the top end from a bottom end thereof.

As shown in FIGS. 2-4, the fuel pump mount assembly 21 is arranged in such a manner that the ring plate 22 surrounds the fuel pump inserting aperture 16e of the fuel tank 16 and the nuts 23 protrude into the wall of the fuel tank 16. As shown in FIGS. 2 and 4, the portions of the fuel pump mount assembly 21 (the plate 22 and the nuts 23) positioned within the wall of the fuel tank 16 are covered with a protrusion, or an embedding section 16f, made from resin forming the fuel tank 16. The embedding section 16f is formed inside of the fuel tank 16 to protrude further inwardly of the fuel tank 16 in an area corresponding to the nuts 23 of the fuel pump mount assembly 21 than an inner surface of the fuel tank surrounding the embedding section 16f. Also, the embedding section 16f is embedded in the recessed portions 23a of the respective nuts 23 to create an interference fit between the nuts 23 and the fuel tank 16.

As shown in FIGS. 2-4, outside of the fuel tank 16, a circular support, or clamp, member 25 screw-fastened by bolts 24 is attached to the fuel pump mount assembly 21 (the nuts 23) embedded in the wall portion of the fuel tank 16. The circular support member 25 has a support section 25a protruding in a radial direction toward a center of the support member 25. Additionally, an aperture 25b of the circular support member 25 defined by the support section 25a has a diameter smaller than the diameter of the disk-shaped attaching section 20a of the fuel pump 20. The attaching section 20a of the fuel pump 20 is interposed between the wall portion on the bottom surface side of the central section 16a of the fuel tank 16 and the support section 25a of the support member 25 outside of the fuel tank 16. Thereby, the body of the fuel pump 20 is fastened to the inside of the fuel tank 16. A seal member 26 for preventing fuel from leaking through a gap between the wall portion of the fuel tank 16 and the attaching section 20a of the fuel pump 20 is inserted into a space between the wall portion on the bottom surface of the central portion 16a of the fuel tank 16.

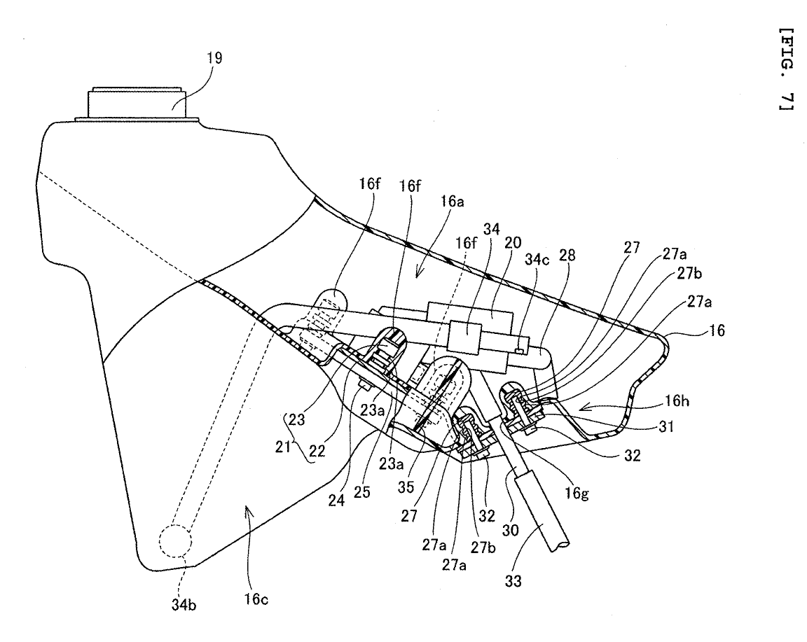

As shown in FIG. 7, a fuel supply opening 16g for supplying the fuel in the fuel tank 16 to the engine 12 (see FIG. 1) is defined in a wall portion on a rear surface of the central section 16a of the fuel tank 16. Two nuts 27 are embedded in the wall portion adjacent to the fuel supply opening 16g of the fuel tank 16. Each nut 27 has two recessed portions 27a circumferentially in an outer surface of the nut 27 to be annular in shape. A bolt hole 27b of each nut 27 is blind, or closed-ended, to inhibit a bolt to pass through the top end portion from a bottom end side of the unit 27. Also, the respective nuts 27 are arranged to protrude to the inside of the fuel tank 16 and are covered with projections made from the resin that is the constituent material of the fuel tank 16. The resin which is the constituent material of the fuel tank 16 is also embedded in the recessed portions 27a of the nut 27.

As shown in FIGS. 6 and 7, a fuel suction pipe 28 for drawing the fuel in the fuel tank 16 is connected to the body of the fuel pump 20. A filter 29 is attached to an end of this fuel suction pipe 28. The filter 29 attached to the fuel suction pipe 28 is placed in a fuel reservoir 16h positioned on the rear surface side of the fuel tank 16. A fuel delivery pipe 30 for delivering the fuel from the fuel pump 20 to the engine 12 (see FIG. 1) is connected to the body of the fuel pump 20. The fuel delivery pipe 30 is arranged to extend to the outside of the fuel tank 16 through a fuel delivery opening 16g of the fuel tank 16. Also, the fuel delivery pipe 30 is fixed to a wall portion on the rear surface of the fuel tank 16 at the fuel delivery opening 16g by an attaching member 31. Additionally, the attaching member 31 is screw-fastened to the wall portion of the fuel tank 16 by bolts 32 coupled with the nuts 27 embedded in the wall portion of the fuel tank 16. Another end of the fuel delivery pipe 30 positioned outside of the fuel tank 16 is connected to the injector 14 (see FIG. 1) through a fuel hose 33.

The body of the fuel pump 20 has an auxiliary pump 34. This auxiliary pump 34 is provided for drawing the fuel which remains in respective bottom portions of the left side section 16b and the right side section 16c of the fuel tank 16 to the fuel reservoir 16h in which the fuel suction pipe 28 (filter 29) of the fuel pump 20 is placed. Specifically, the auxiliary pump 34 has two auxiliary suction ports 34a and 34b and one discharge port 34c. The auxiliary suction ports 34a of the auxiliary pump 34 is positioned in the bottom portion of the left side section 16b of the fuel tank 16, while the auxiliary suction ports 34b of the auxiliary pump 34 is positioned in the bottom portion of the right side section 16c of the fuel tank 16. The discharge port 34c of the auxiliary fuel pump 34 is positioned in the fuel reservoir 16h of the fuel tank 16. Thereby, the fuel remaining in the respective bottom portions of the left side section 16b and the right side section 16c of the fuel tank 16 is drawn through the auxiliary suction ports 34a and 34b of the auxiliary pump 34, and the sucked fuel is discharged to the fuel reservoir 16h through the discharge port 34c of the auxiliary pump 34.

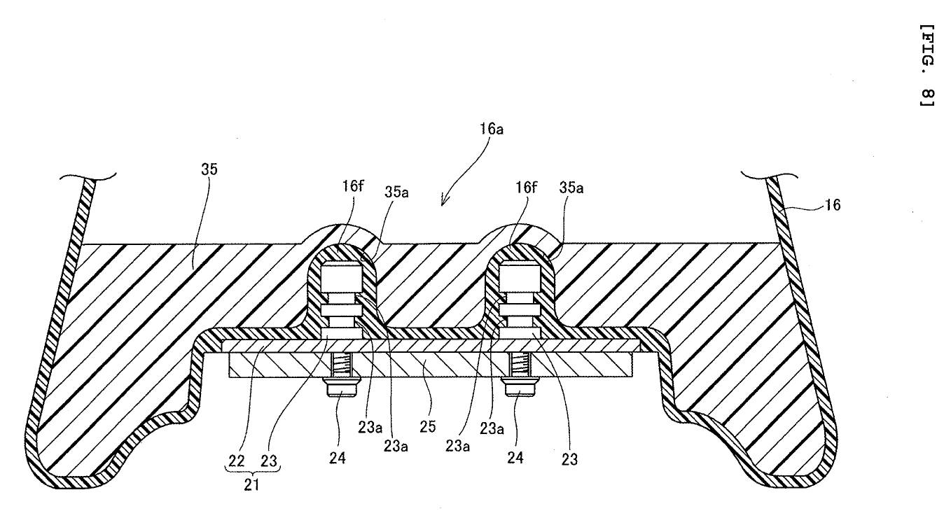

As shown in FIGS. 6-8, inside of the fuel tank 16, a partition plate 35, or partition, is arranged to partition a front side where the left side section 16b and the right side section 16c of the fuel tank 16 are positioned and a rear side where the fuel reservoir 16h is positioned from each other. This partition plate 35 has a function of preventing the fuel discharged from the discharge port 34c of the auxiliary pump 34 to the fuel reservoir 16h of the fuel tank 16 from flowing back to the respective bottom portions of the left side section 16b and the right side section 16c of the fuel tank 16. As shown in FIG. 8, two recessed portions 35a are formed in a central section of the partition plate 35. The partition plate 35 is put on the embedding section 16f protruding to the inside of the fuel tank 16 so as to be fixed to the inside of the fuel tank 16.

As described above, the fuel pump mount assembly 21 embedded in the wall portion of the fuel tank 16 includes the one aluminum plate 22 and six nuts 23 fixed to the plate 22. Thus, when the fuel tank 16 having the wall portion where the fuel pump mount assembly 21 is embedded is molded by the process in which resin is molded (insert molding), even though the resinous molded work that functions as the fuel tank 16 later shrinks in a cooling process, the six nuts 23 are prevented from moving due to being pulled by the shrinking resin because the six nuts 23 of the fuel pump mount assembly 21 are fixed to the aluminum plate 22. Thereby, when the fuel pump 20 disposed inside of the fuel tank 16 is fastened using the fuel pump mount assembly 21 (nuts 23), the position where the fuel pump 20 is fastened can be prevented from displacing from the desired position. As a result, fuel leaks between the wall portion of the fuel tank 16 and the fuel pump 20 caused by the position where the fuel pump 20 is fastened is off from the desired position can be avoided.

In this arrangement, as described above, the portion of the fuel pump mount assembly 21 (the plate 22 and the nuts 23) positioned inside of the fuel tank 16 is covered with the resin that is the constituent material of the fuel tank 16. Therefore, inside of the fuel tank 16, the boundary portion between the resin forming the fuel tank 16 and the fuel pump mount assembly 21 (the plate 22 and the nuts 23) is not exposed. Thus, the occurrence of a fuel leak caused by the fuel entering the boundary portion between the resin forming the fuel tank 16 and the fuel pump mount assembly 21 (the plate 22 and the nuts 23) is inhibited or prevented.

As described above, because the resin that is the constituent material of the fuel tank 16 is embedded in the recessed portions 23a of each nut 23, the nuts 23 of the fuel tank fixing unit 21 are securely joined to the wall portion of the fuel tank 16. The fuel pump mount assembly 21 thus is prevented from separating from the wall portion of the fuel tank 16 due to the interference fit between the nuts 23 and the fuel tank 16.

As described above, because the respective nuts 23 of the fuel pump mount assembly 21 are made from aluminum and are caulked to the aluminum plate 22, the nuts 23 can be easily fixed to the aluminum plate 22.

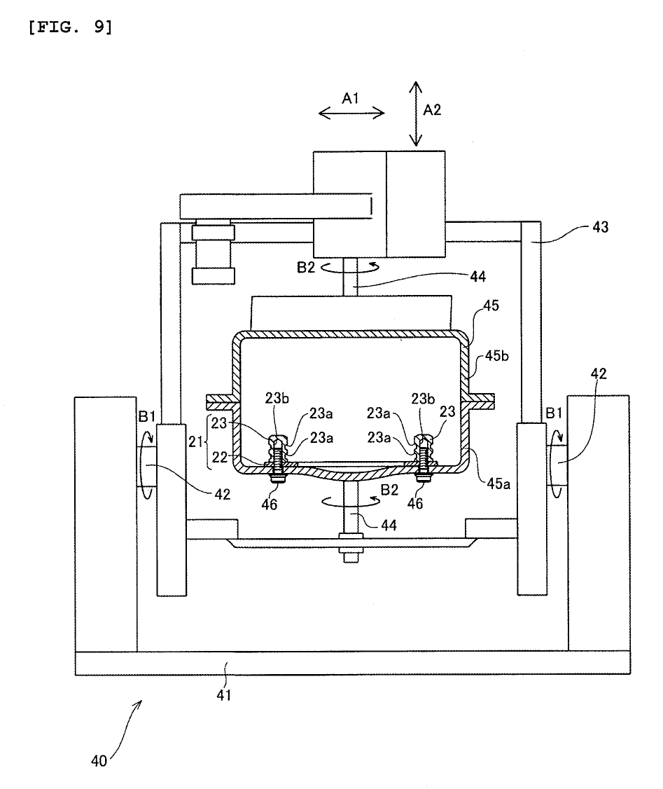

FIGS. 9-11 are schematic illustrations of a manufacturing method of the fuel tank of the motorcycle according to an embodiment of the present invention. With reference to FIGS. 2-5 and 9-11, a manufacturing method of the fuel tank of the motorcycle according to an embodiment of the present invention is described.

As shown in FIG. 5, the aluminum plate 22 formed in the shape of a ring and the six aluminum nuts 23 each having the two recessed portions 23a defined circumferentially in the outer surface thereof are assembled. The aluminum nuts 23 are caulked (adhered, preferably with a sealing adhesive) to the aluminum plate 22, thereby fixing the nuts 23 to the plate 22. On this occasion, the six nuts 23 are spaced apart from each other by a predetermined distance (pitch) between the centers of the neighboring nuts 23. The fuel pump mount assembly 21 including the one aluminum plate 22 and the six aluminum nuts 23 fixed to the plate 22 is formed.

Next, the fuel tank 16 (see FIG. 2) having the wall portion in which the fuel pump mount assembly 21 is embedded is formed by rotational molding. Below, a manner of forming the fuel tank 16 by rotational molding is described.

First, in a structure of a rotational molding device 40 used for forming the fuel tank 16, as shown in FIG. 9, a movable support unit 43 is attached to a fixed support unit 41 through a pair of rotary shafts 42 extending in the direction A1 for rotation in the direction B1. A pair of rotary shafts 44 extending in the direction A2 crossing at right angles with the direction A1 and rotating in the direction B2 are attached to the movable support unit 43. A metal mold 45 for the rotational molding device 40 is attached to the movable support unit 43 via the pair of rotary shafts 44. Thereby, the metal mold 45 for rotational molding is rotated in the direction B2 while rotating in the direction B1. Additionally, the metal mold 45 for rotational molding is formed with a lower mold 45a and an upper mold 45b.

When the fuel tank 16 (see FIG. 2) is formed by the rotational molding device 40 described above, first, the fuel pump mount assembly 21 is attached to the inside of the metal mold 45 for rotational molding. The fuel pump mount assembly 21 is disposed on a bottom surface of the lower mold 45a of the metal mold 45. Specifically, the fuel pump mount assembly 21 is screw-fastened to the lower mold 45a of the mold 45 by the bolts 46 coupled with the nuts 23 of the fuel pump mount assembly 21. The nuts 23 of the fuel pump mount assembly 21 are arranged to protrude inwardly of the metal mold 45 for rotational molding. Additionally, the metal mold 45 including a lower mold 45a formed in such a manner that an area surrounded by the fuel pump mount assembly 21 in the shape of a ring swells from the inside to the outside is used as the metal mold 45. In other words, an inner surface of mold 45 in the area surrounded by the fuel pump mount assembly 21 is concave.

Next, a resin powder (not shown) is fed into the inside of the metal mold 45 and the metal mold 45 is heated. Thereafter, the metal mold 45 is rotated in the directions B1 and B2 so that the resin melted by the heat evenly adheres to the inner surface of the metal mold 45 for rotational molding. Thereby, the fuel pump mount assembly 21 (the plate 22 and the nuts 23) is covered with the resin and the resin is embedded in the recessed portions 23a of each nut 23.

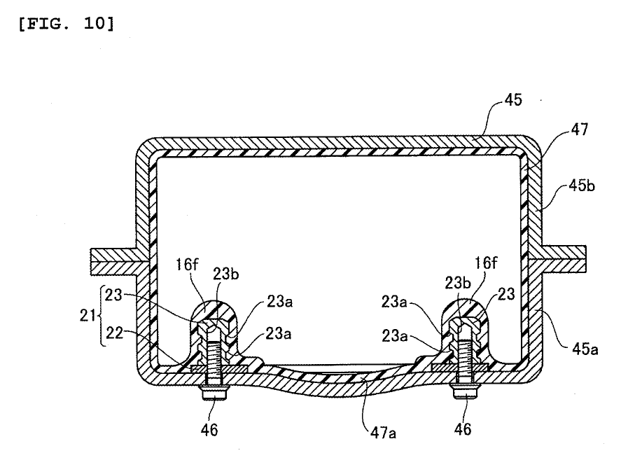

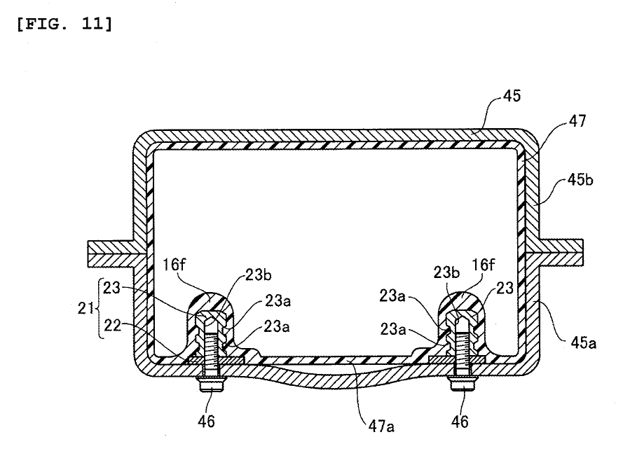

Next, the metal mold 45 is cooled to harden the melted resin (not shown) contained therein. Thereby, as shown in FIG. 10, the resinous molded work 47 that becomes the fuel tank 16 (see FIG. 2) is formed. The resinous molded work 47 in the metal mold 45 shrinks while the metal mold 45 is being cooled. That is, the area (area surrounded by the fuel pump mount assembly 21) 47a of the resinous molded work 47 that is formed to swell from the inside to the outside shrinks from the outside to the inside. Accordingly, as shown in FIG. 11, the area of the resinous molded work 47 surrounded by the fuel pump mount assembly 21 substantially shrinks to form a flat surface. Afterwards, the resinous molded work 47 is taken out from the inside of the metal mold 45.

Next, as shown in FIGS. 2-4, after forming the fuel pump inserting aperture 16e in the wall portion on the bottom surface of the central section 16a of the fuel tank 16, the body of the fuel pump 20 is inserted into the inside of the fuel tank 16. Afterwards, the support member 25 is screw-fastened to the fuel pump mount assembly 21 (nuts 23) to interpose the attaching section 20a of the fuel pump 20 between the wall portion of the fuel tank 16 and the support section 25a of the support member 25. Thereby, the body of the fuel pump 20 positioned inside of the fuel tank 16 is fastened.

In the above-described method for manufacturing the motorcycle fuel tank 16, after assembling the fuel pump mount assembly 21 including the one aluminum plate 22 and the six nuts 23 by securing the nuts 23 to the plate 22, the resinous fuel tank 16 having the wall portion where the fuel pump mount assembly 21 is embedded is formed by rotational molding. Thus, even though the resinous molded work 47 that functions as the fuel tank 16 later shrinks in the cooling step, the six nuts 23 are prevented from moving due to being pulled by the shrinking resin because the six nuts 23 of the fuel pump mount assembly 21 are fixed to the one aluminum plate 22. Thereby, when the fuel pump 20 disposed inside of the fuel tank 16 is fastened using the fuel pump mount assembly 21 (nuts 23), the position where the fuel pump 20 is fastened can be prevented from moving from the desired position. As a result, fuel leaks between the wall portion of the fuel tank 16 and the fuel pump 20 when the position where the fuel pump 20 is fastened is displaced from the desired position can be avoided.

Also, in the manufacturing method of the motorcycle fuel pump 16, as described above, the fuel tank 16 having the wall portion where the fuel pump mount assembly 21 is embedded is formed by rotational molding. Therefore, even though the fuel pump mount assembly 21 has a complicated configuration, the fuel tank 16 can be formed only in one molding step. Thereby, the manufacturing steps of the fuel tank 16 can be simplified.

In the method for manufacturing the motorcycle fuel pump 16 described above, by using the metal mold 45 which includes the lower mold 45a formed in such a manner that the area surrounded by the fuel pump mount assembly 21 in the shape of a ring is concave in shape, when the resinous molded work 47 that functions as the fuel tank 16 later shrinks, the concave-shaped area (area surrounded by the fuel pump mount assembly 21 in the shape of a ring) 47a shrinks from the outside to the inside. The area of the fuel tank 16 surrounded by the fuel pump mount assembly 21 thus ends up being a substantially flat surface. Therefore, when the fuel pump 16 is fastened to the wall portion positioned in the area of the fuel tank 16 surrounded by the fuel pump mount assembly 21, a gap is prevented from occurring between the wall portion of the fuel tank 16 and the fuel pump 20. Thus, further means to prevent fuel from leaking between the wall portion of the fuel tank 16 and the fuel pump 20 is provided.

Additionally, the embodiments disclosed herein are exemplary and should not be considered to be restrictive. The scope of the present invention is not limited by the above descriptions of the embodiment but by the claims, and includes all variations in the meanings of claims and equivalents thereof. For example, in the embodiments described above, an example in which the present invention is applied to a motorcycle is shown. The present invention, however, is not limited to the motorcycle and can be applied to any vehicles other than motorcycles. Also, in the embodiments described above, the fuel tank having a generally saddle shape is used. The present invention, however, is not limited to such a fuel tank and a fuel tank having any shape can be used. Further, in the embodiments described above, the fuel pump mount assembly is embedded in the wall portion of the central section of the fuel tank. The present invention, however, is not limited to such a structure. The fuel pump mount assembly can be embedded in the left side section of the fuel tank, or the fuel pump mount assembly can be embedded in the right side section of the fuel tank or elsewhere within a fuel tank.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. In particular, while the present vehicle and fuel tank have been described in the context of particularly preferred embodiments, the skilled artisan will appreciate, in view of the present disclosure, that certain advantages, features and aspects of the vehicle and fuel tank may be realized in a variety of other applications, many of which have been noted above. Additionally, it is contemplated that various aspects and features of the invention described can be practiced separately, combined together, or substituted for one another, and that a variety of combination and subcombinations of the features and aspects can be made and still fall within the scope of the invention. Thus, it is intended that the scope of the present invention herein disclosed should not be limited by the particular disclosed embodiments described above, but should be determined only by a fair reading of the claims.

What is claimed is:

1. A vehicle comprising:
a fuel tank having a wall constructed from a resin-based material;
a fuel pump positioned within the fuel tank; and
a fuel pump mount assembly for securing the fuel pump to the fuel tank, wherein the fuel pump mount assembly comprises a plate secured to at least one nut, wherein at least a portion of the fuel pump mount assembly is embedded in a wall of the fuel tank.

2. The vehicle of claim 1, wherein an inner surface of the wall of the fuel tank defines at least one protrusion that accommodates a portion of the fuel pump mount assembly.

3. The vehicle of claim 2, wherein the at least one protrusion accommodates the at least one nut of the fuel pump mount assembly.

4. The vehicle of claim 3, wherein at least a portion of the at least one nut protrudes beyond the inner surface of the wall of the fuel tank surrounding the at least protrusion.

5. The vehicle of claim 3, wherein the nut of the fuel pump mount assembly comprises a recess formed in an outer surface of the at least one nut, and wherein the resin material forming the portion of the wall in which the at least one nut is embedded fills the recess to create an interference fit between the at least one nut and the fuel tank.

6. The vehicle of claim 3, further comprising a partition wall within the fuel tank, wherein the partition wall is integrally formed with the at least one protrusion.

7. The vehicle of claim 1, wherein both the at least one nut and the plate of the fuel pump mount assembly are made from a metal material, and the at least one nut is secured to the metal plate by an adhesive.

8. The vehicle of claim 7, wherein the adhesive is selected to create a seal between the at least one nut and the plate.

9. The vehicle of claim 1, wherein the plate is generally in the shape of a ring, the at least one nut comprises a plurality of the nuts, and the plurality of the nuts are arranged on the plate such that a center of the respective nuts are spaced from one another by a predetermined distance.

10. A method for manufacturing a fuel tank for a vehicle, comprising:
assembling a fuel pump mount assembly by securing at least one nut to a plate;
forming a fuel tank from a resin-based material having a wall portion by a rotational molding process, wherein a portion of the fuel pump mount assembly is embedded in the wall portion of the fuel tank; and
securing the fuel pump to the fuel tank using the fuel pump mount assembly such that the fuel pump is disposed within the fuel tank.

11. The method of claim 10, wherein the forming of the fuel tank comprises:
positioning the fuel pump mount assembly inside of a mold; and
introducing a resin powder into the mold and causing the resin powder adhere to an inner surface of the mold, wherein the plate is annular in shape and at least a portion of an area of the inner surface of the mold surrounded by the plate defines a concave shape.

12. The method of claim 10, wherein the forming of the fuel tank comprises:
positioning the fuel pump mount assembly inside of a mold; and
introducing a resin powder into the mold and causing the resin powder to adhere to an inner surface of the mold such that a portion of the fuel pump mount assembly is covered by the resin powder.

13. The method of claim 10, wherein the forming of the fuel tank comprises:
positioning the fuel pump mount assembly inside of a mold such that the at least one nut protrudes within the mold; and
introducing a resin powder into the mold and causing the resin powder to adhere to an inner surface of the mold such that that the at least one nut of the fuel pump mount assembly is covered by the resin powder.

14. The method of claim 13, wherein the forming of the fuel tank further comprises forming a partition wall within the fuel tank that is integral with a portion of the fuel tank covering the at least one nut.

15. The method of claim 13, wherein the at least one nut of the fuel pump mount assembly has a recessed portion defined in an outer surface of the nut, and wherein the causing the resin powder to adhere to the inner surface of the mold comprises causing the resin powder to become embedded in the recessed portion of the nut.

16. The method of claim 10, wherein the assembling of the fuel pump mount assembly comprises securing the at least one nut to the plate with an adhesive.

17. The method of claim 16, wherein the adhesive is selected to provide a seal between the at least one nut and the plate.

18. The method of claim 16, wherein the assembling of the fuel pump mount assembly comprises securing the at least one nut to the plate with a bolt.

19. The method of claim 10, wherein the assembling of the fuel pump mount assembly comprises securing the at least one nut to the plate with a bolt.

20. A vehicle comprising:
a fuel tank constructed from a moldable material;
a fuel pump positioned within the fuel tank; and
a fuel pump mount assembly securing the fuel pump to the fuel tank, wherein the fuel pump mount assembly comprises at least one fastening mechanism secured to a plate, wherein at least a portion of the fuel pump mount assembly is embedded in a wall of the fuel tank.
